(19) United States
(12) Patent Application Publication
(10) Pub. No.: US 2013/0104150 A1
(43) Pub. Date: Apr. 25, 2013

(54) SERVICE BASED INFORMATION TECHNOLOGY PLATFORM

(71) Applicants: Steven Michael Rdzak, Arvada, CO (US); Paul William Farnsworth, Castle Rock, CO (US)

(72) Inventors: Steven Michael Rdzak, Arvada, CO (US); Paul William Farnsworth, Castle Rock, CO (US)

(73) Assignee: Level 3 Communications, LLC, Broomfield, CO (US)

(21) Appl. No.: 13/278,037

(22) Filed: Oct. 20, 2011

(51) Int. Cl. G06F 9/46

(52) U.S. Cl. 719/328

(57) ABSTRACT

A Service-Base Information Technology Platform may facilitate the integration of heterogeneous technologies and disparate internal or external business applications. A services platform may provide a robust and managed environment for delivering business capabilities through services. The services encapsulate heterogeneous technologies and disparate internal or external business applications functionalities into business capabilities that multiple consumers may use.

### TECHNICAL FIELD

Aspects of the present disclosure relate to platforms for integrating heterogeneous technologies and/or applications into business services.

### BACKGROUND

Many businesses today operate using a variety of older heterogeneous technologies, business applications, and other technological business resources, collectively known as “legacy systems,” to perform different business transactions. For example, legacy systems may be used for consumer transactions, payroll systems, and business data management. In order to meet the changing needs of a business, legacy systems are gradually modified and extended over many years, and often become fundamental to the performance and success of the business.

It is often the case that such legacy systems cannot be efficiently replaced, due to their complexity, size, fragmented nature, and interconnections with other systems. However, as the modern economy becomes more technologically complex and business requirements and opportunities change, many businesses require cross-enterprise collaborations among existing legacy systems and other business technologies, applications, and resources, as well as integration with new external technologies and systems, such as business-to-consumer and/or business-to-business applications. Often, an organization inherits various systems from corporate acquisitions and acquires systems that become unsupported over time. Integrating these systems into existing infrastructure and maintaining these systems may involve redundant functionality and data, and eliminating those redundancies can be difficult and expensive. Conventionally, integrating, reducing and eliminating redundancies, and/or extending existing business technologies and applications, or integrating existing business technologies and applications with newer external systems is difficult because of inconsistent interfaces, fragmented, differently formatted, and/or redundant data sources, and inflexible architectures.

It is with these problems in mind, among others, that various aspects of the present disclosure were conceived.

### SUMMARY

One aspect of the present disclosure involves an enterprise information technology platform. The system includes at least one processor and a memory in operable communication with the at least one processor. The system includes a services platform, executing on the at least one processor. The services platform includes a plurality of API services, wherein each API service of the plurality of API services accesses one or more business assets to implement a business capability. The services platform also includes a data services infrastructure to receive business data from at least one data source, the business data used to enable the API services. The services platform includes at least one orchestrated business process service to consolidate at least two of the plurality of API services to enable a complex business capability. The services platform further includes a management communications infrastructure to: coordinate communication between the plurality of API services to enable selection of the at least two API services and communicate the business data from the data services infrastructure for the at least two API services to the at least one orchestrated business process service.

In another aspect, a method for providing access to a plurality of API services, wherein each wherein each API service of the plurality of API services accesses a business asset to implement a business capability is disclosed. The method includes establishing communication between the plurality of API services and a data services infrastructure. The method also includes receiving business data from at least one data source, the business data used for enabling the at least one API service of the plurality of API services. The method further includes generating at least one orchestrated business process service to perform a complex business capability, wherein the at least one orchestrated business process consolidates at least two of the plurality of API services. The method includes communicating the business data for the at least two API services to the at least one orchestrated business process service.

In yet another aspect, a computer-readable medium encoded with a services platform comprising one or more applications and infrastructures executable by a processor is disclosed. The services platform includes an API services application comprising a plurality of API services wherein each API service of the plurality of API services accesses one or more business assets to implement a business capability. The services platform further includes a data services infrastructure to receive business data from a plurality of data sources, the business data used to enable the plurality of API services. The services platform also includes a orchestrated business process service application to generate at least one orchestrated business process service to consolidate at least two of the plurality of API services to enable a complex business capability. The services platform includes a management communications infrastructure to: coordinate communication between the plurality of API services to enable selection of the at least two API services and communicate the business data from the data services infrastructure for the at least two API services to the at least one orchestrated business process service.

### BRIEF DESCRIPTION OF THE FIGURES

Aspects of the present disclosure may be better understood and its numerous objects, features, and advantages, made apparent to those skilled in the art by referencing the accompanying drawings. It should be understood that these drawings depict only typical embodiments of the present disclosure and, therefore, are not to be considered limiting in scope.

FIG. 1 is an example computing environment for a services platform in accordance with one aspect of the present disclosure.

FIG. 2 is block diagram of the service platform in accordance with one aspect of the present disclosure.

FIG. 3 is a block diagram depicting one embodiment of the API services application in accordance with an aspect of the present disclosure.

FIG. 4 is block diagram of the orchestrated business process services application in accordance with one aspect of the present disclosure.

FIG. 5 is block diagram of the data services application in accordance with one aspect of the present disclosure.

FIG. 6 is block diagram of the data integration and acquisition services application in accordance with one aspect of the present disclosure.

FIG. 7 is block diagram of the managed communications application in accordance with one aspect of the present disclosure.

FIG. 8 is block diagram of the utility services application in accordance with one aspect of the present disclosure.

FIG. 9 is a flow diagram illustrating an example method for providing a Service Based IT Platform in accordance with one aspect of the present invention.

### DETAILED DESCRIPTION

Aspects of the present disclosure extend to methods, systems, and computer program products for providing a set of business capabilities to end users, such as customers, partners, and/or information technology (“IT”) developers. A services platform provides one or more application programming interface services (“API services”) to such users. Each API service accesses and/or integrates different business application functionalities and business data that extend across a business enterprise to implement a shared reusable business capability. The API services may be combined into orchestrated business process services, which may be used to enable complex business capabilities. End users, such as IT developers, may access and use the API services and orchestrated business process services to create new business applications and/or extend existing business applications. Aspects of the present disclosure may facilitate creating functional interconnections between existing legacy systems, between legacy systems and new systems, and between other business systems, reducing redundant data and systems among the various business systems, and sharing common data among the various business systems.

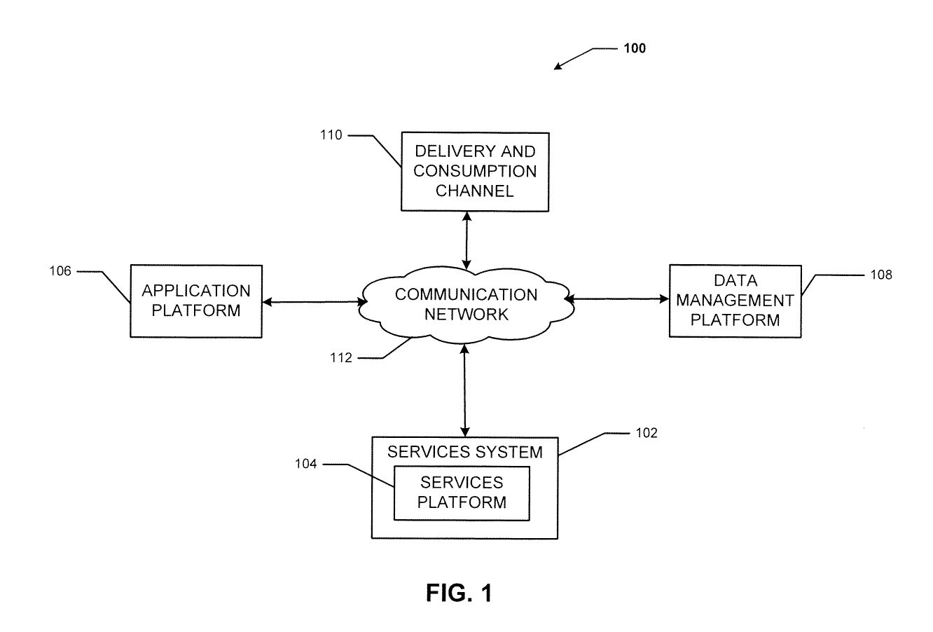

FIG. 1 illustrates an example computing environment 100 for providing API services to end users. A services system 102 executes a services platform 104 that may implement a service-oriented architecture (“SOA”) in conjunction with an outside-in architecture and web-oriented architecture principles to provide one or more API services. SOA generally describes the arrangement, coordination, and management of heterogeneous computer systems. In a business context, SOA encapsulates and abstracts the functionality and implementation details of different business assets into a number of individual services. A business asset refers to any disparate, external, internal, custom, and/or proprietary business software application, database, technology, system, packaged commercial application, file system, or any other type of technology component capable of performing business tasks or providing access to business data. For example, business assets relating to payroll may include: an employee payroll application, a payroll accounting and auditing application, and a SQL Server™ managed payroll employee database. Generally, SOA services are accessible by users through a well-defined shared format, such as a standardized interface, or by coordinating an activity between two or more services. Users access the service interfaces, for example over a network, to develop new business applications or access and/or extend existing applications.

An outside-in architecture is an inherently top-down architecture that emphasizes decomposition to the functional level and is service oriented rather than application oriented. Outside-in architectures push services far down into an outside-in architecture stack (as close to the technology that offers the business service as possible), removing the need to use middleware that may be redundant.

A web-oriented architecture is a software architecture style that extends architectures, such as service oriented architectures, to web based applications. Web-oriented architectures are interface-level architectural styles that focus on the means by which services and service capabilities are exposed to consumers. For example, web-oriented architectures may be used to create web mashups, which are applications that use and combines data, presentation, or functionality from two or more sources to create new services. While the service-oriented architecture and the outside-in architecture are discussed herein, it is contemplated that other service-based and web-based architectures may also be used in the implementation of the services platform 104.

According to one aspect, the services platform 104 may combine business functionalities and business data from various business assets into one or more individual API services. Each API service may be a standardized interface that is implemented independent of the underlying business functionality and/or business data. Separating the business functionalities and business data from the interface for a given API service reduces dependencies between the various business assets so that changes to one business asset do not adversely impact or influence other business assets. Additionally, the separation allows the underlying business asset functions and business data to change without changing how an end user interacts with the interface to access such functions and data. End users, such as IT developers may use the standard interface of each API service to develop new business applications and integrate and/or extend existing business applications without knowing each API services' underlying implementations.

Aspects of each standard interface may include a data infoset (e.g. XML or JSON) which provides business data and contextual data in a programming friendly form, a limited set of programming operations with uniform semantics (e.g., GET or PUT) to create programming consistency across a large API services inventory, a uniform addressing scheme for locating (e.g., service category/service name/interface) and accessing individual services in the API service inventory, a uniform exception reporting scheme for dealing with faults in the API service inventory, use of standard networking protocols (e.g., HTTP) for connecting API service consumers to API service providers in a distributed API services system.

The specific underlying combination of business functionalities and business data for each API service provided by the services platform 104 implements corresponding specific business capability. A business capability is a collection of functionalities and related technologies that perform a specific business function for the purpose of achieving a business outcome or task. More particularly, a business capability defines what a business does (e.g. ship product, pay employees, check credit) and how that function is viewed externally (visible outcomes) in contrast to how the business performs the activities (business process) to provide the function and achieve the outcomes. For example, a “customer” API service may combine access to a proprietary customer database and the functionality of a customer relations management application to provide the business capability of customer management through a standard interface. The “customer” API service may be reused in multiple high-level business applications to provide the customer management business capability. If the customer API service did not combine the functionality of the customer relations management application and the proprietary customer database, would have to integrate access for every high-level business application necessary.

In order to implement and/or enable a business capability, each API service may access one or more business assets, such as business applications, servers, databases, and or other business technologies for a business enterprise. For example, the API services provided by the services platform 104 may access business applications in an application platform 106. Business applications include computer programs, software, instructions, etc., that may be used to perform and/or execute business transactions for a business. For example, a point of sales system managing customer sales for a retail business constitutes a business application. In another aspect, the application platform 106 may include the set of business assets currently existing within a business enterprise. According to one aspect, the application platform 106 may include non-service enabled business assets and/or service enabled business assets. A service enabled asset is a technology resource of the application platform that has been engineered to provide access to the business capabilities of the application through a proprietary API service that is specific to that one asset (e.g. web services for Oracle Siebel 8.1). In contrast, a non-service enabled asset provides no engineered access to the business capabilities through a proprietary API service and requires directly accessing the asset's database and/or using adapters provided by third party vendors to gain use of the business capabilities of the application. Both the service enabled business assets and the non-service enabled business assets may be used by the services platform 104 to provide API services. The API services access business functionalities and related business data from the non-service enabled business assets and/or service enabled assets of the application platform 106.

Additionally, each API service may access or receive business data from a business enterprise. Business data refers to any type of data created, generated, stored, modified, and/or captured during a business transaction, or any data related to a business operation. For example, business data may include customer order invoices, customer contact information, employee contact information, product inventory data, product management data, etc. Business data may also include any data existing on, or in, a business application, database, server and/or other type of business asset.

The business data accessed by each API service may be used to enable the business capability provided by an API service. Data from files on file systems, data in relational database management systems (RDBMS) or unstructured data in the form of documents are a few examples of the technical mechanisms that facilitate the collection of business data for a particular business. The data in these various repositories and/or stores provide the sources for creation of the data infosets of an API service interface.

According to one example, the API services may access business data found in a data management platform 108. The data management platform 108 represents a flexible and extensible data management environment that delivers business data to the API services. The data management platform 108 may automate the distribution of business data such as: historical business data, customer and sales business data, network inventory business data, work flow business data, and/or any other type of business data to the respective API service of the services platform 104. According to another aspect, the business data may be received and/or retrieved from another processing device such as a computer, server, mobile device, and/or any other type of processing device.

The services may be provided by the services platform 104 to one or more end users, such as customers, business partners, and/or IT developers. For example, the API services provided by the service platform 104 may be accessible to an IT developer through a delivery and consumption channel 110. The delivery and consumption channel 110 may be a computer, a processing device, a communication device, or the like, such as a personal computer, a server computer, a tablet computer, a mobile processing device, a mobile communication device, and/or the like. The delivery and consumption channel 110 may also be a portal (e.g. a web portal), fat client, software application, composite software application, situational mashup application, dashboard, business intelligence tool, and/or an E-Commerce infrastructure comprising a customer portal and external application programming interface.

An IT developer may use the delivery and consumption channel 110 to develop new business applications, extend the functionality of existing business applications, and/or integrate existing business technologies using the API services offered by the services platform 104. For example, an IT developer interested in developing new functionality for a legacy customer service system may access a web portal (the delivery and consumption channel) to access the “customer” API service API of the services platform 104. The IT developer may then implement additional functionality for the legacy customer service system using the customer API service.

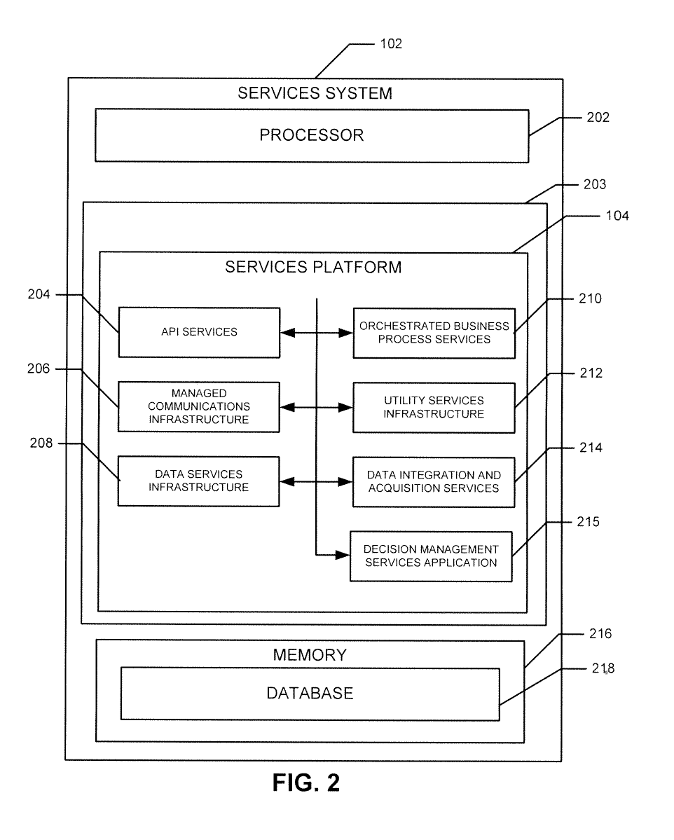

FIG. 2 is a block diagram illustrating the services system 102 according to aspects of the present disclosure. The services system 102 includes a processor 202 that may be used to execute the services platform 104 to provide API services to end users. The processor 202 may be in communication with a memory 216. The memory 216 may include volatile and/or non-volatile memory, and provides a database 218 to store business data. According to one aspect, database 218 is a general repository of data including but not limited to business data. The database 218 may include memory and one or more processors or processing systems to receive, process, query and transmit communications and store and retrieve data. In another aspect, the database 218 may be a database server.

The services system 102 may include a computer readable media (“CRM”) 203 storing executable instructions to implement the services platform 104. The CRM 203 may include computer storage media, communication media, and/or another available media medium that can be accessed by the processor 202. For example, CRM 203 comprises computer storage media and communication media. By way of example and not limitation, computer storage media includes memory, volatile media, nonvolatile media, removable media, and/or non-removable media implemented in a method or technology for storage of information, such as computer readable instructions, data structures, program modules, or other data. Communication media includes computer readable instructions, data structures, program modules, or other data and include an information delivery media or system.

The services platform 104 executes a variety of software components, infrastructures, sub platforms, and/or applications that communicate to provide API services to end users. A software component is a software package, web service, application, or module that encapsulates a set of related functions or data. Software infrastructures include computer software, applications (e.g. operating systems, middleware, virtual machines, etc.), instructions, modules and/or code that interface applications with low-level hardware devices and/or other software applications; provide communication mechanisms for cooperation among the devices and applications; and manage resources between the devices and/or applications. Although the services platform 104 is depicted as executing multiple applications, software components, and/or software infrastructures, it is contemplated that all of the applications, software components, and software infrastructures of the services platform 104 may be combined in various ways.

In one embodiment, the services platform 104 includes an API services application (“ASA”) 204, a managed communications infrastructure (“MCI”) 206, a data services infrastructure (“DSI”) 208, an orchestrated business process services application (“OBPSA”) 210, a utility services infrastructure (“USI”) 212, a data integration and acquisition services application (“DIASA”) 214, and a decision management services application (“DMSA”) 215 that are implemented in computer executable instructions and/or modules stored in the CRM 203 and may be executed by the processor 202 as part of the services platform 104. Generally, program modules and/or instructions include routines, programs, objects, components, data structures, etc., that perform particular tasks or implement particular abstract data types.

The ASA 204 provides one or more API services to end users. As described herein, an API service accesses different business asset functionalities and business data to implement a core, reusable, business capability. The API services may be delivered by the services platform 104 to one or more end users such as through the delivery and consumption channel 110.

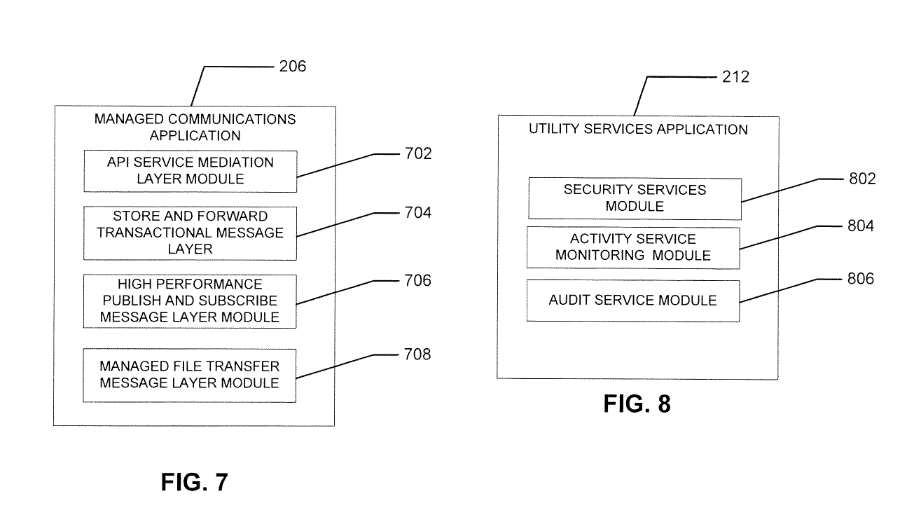

The MCI 206 enables and coordinates communication among the various components and infrastructures in the services platform 104. For example, the MCI 206 may coordinate communication between the ASA 204, the DSI 208, the OBPSA 210, the USI 212, and the DIASA 214. According to one aspect, the MCI 206 includes a set of technologies that enable distributed components of the service platform 102 to connect, communicate and share data. The individual modules of the MCI are designed and tuned to deliver different performance and quality of service (QOS) semantics for certain business usage scenarios. For example, a store and forward transactional message layer module 704, discussed with reference to FIG. 7, is designed for reliable delivery of data, and a high performance publish and subscribe message layer module 706 is designed for rapid delivery of data. Based on the needs of a business, one or more, or all of the modules of the MCI 206 may be used to meet the different communication requirements of the business capabilities.

The DSI 208 unifies and extends existing information architectures of a business enterprise to make business data more accessible and usable. The DSI 208 exposes business data in a unified view, so that end users can use a single source when using the business data to enable API services. The DSI 208 provides a technical mechanism to bring together two or more sources of similar business data and expose those multiple sources in a single access point, such as a delivery and consumption channel, to a data service consumer and/or user. The fragmented and distributed nature of data in businesses today makes it costly and time consuming to compile business data in a single geographic location or technical repository. Accordingly, the DSI 208 makes the data more accessible by virtualizing the location and sources and providing a single point of access for data consumers, applications, developers, etc. For example, the DSI 208 may make business data accessible in real-time. As another example, the DSI 208 may provide a single virtual point of access to business data.

The OBPSA 210 combines one or more of the API services provided by the ASA 204 into a business process service that may be used to perform complex business capabilities. Generally, service orchestration describes the automated arrangement, coordination, and management of services offered by a service-oriented architecture. Individual services are and their corresponding capabilities are combined together to automate the performance of complex business capabilities. For example, the orchestrated business process services component may combine individual API services from the ASA 204 including: an “invoice” API service, an “order” API service, and a “customer” API service into an orchestrated business service that may be used to automatically perform the complex business transaction of processing customer product returns.

The USI 212 provides secure access to the API services provided by the ASA 204. Additionally, the USI 212 may provide the means to capture metrics for API service invocations and enable alert mechanisms based off of the API service invocation content. For example, capturing metrics may entail the tracking of the number of service calls from a customer portal per day for an Order Status API service and the average response time for that service to aid in understanding usage and performance for use in capacity planning and proactive performance tuning. As another example, an alerting mechanism may entail the setting of a performance service level (SLA) of the Order Status API service to provide a response to a service consumer within 5 seconds or less and proactively alerting operations managers if invocation response time begins to exceed the 5 second SLA so corrective actions can be put in motion to minimize impact to the customer experience. Finally, the USI 212 may provide auditing services for monitoring the use of API services.

The services platform 104 may also include a DIASA 214. The DIASA 214 provides a data extraction, transformation and loading (ETL) service and a data change event special purpose service for the services platform 104 to enable the processing and movement of distributed sources of business data from the distributed sources into the data management platform 108 for subsequent usage in decision support and historical trend analysis activities.

The services platform 104 may include a DSMA 215. According to one aspect, the DMSA 215 externalizes volatile business policies and rules from applications and services, such as API services, so that the rules that make up a decision are decoupled from the logic that requires the decision be made.

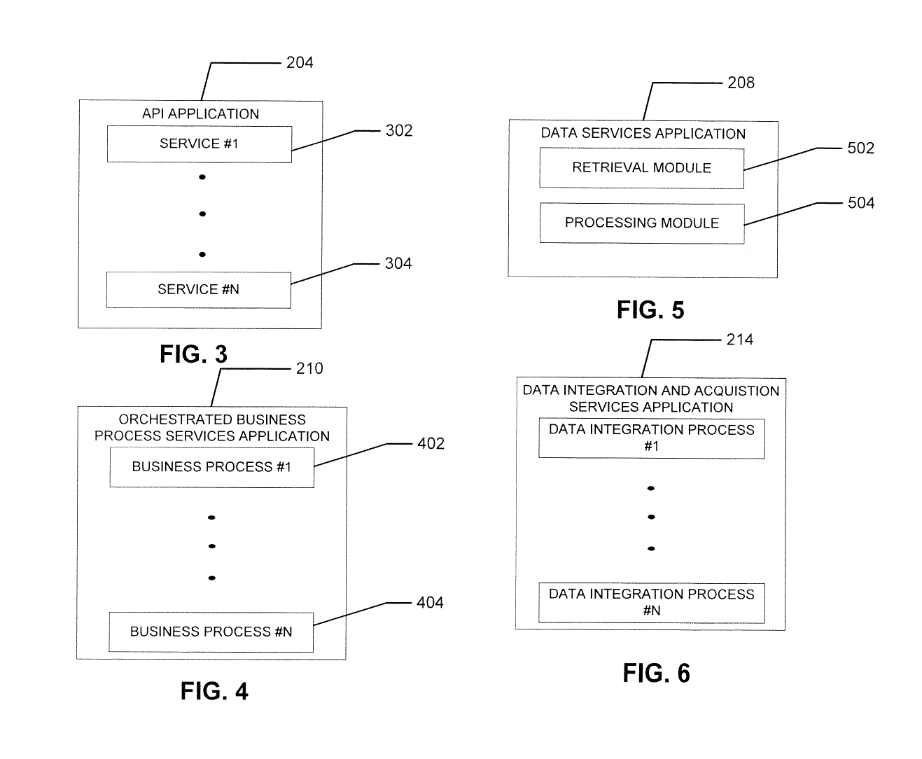

As described above, in one embodiment, the services platform 104 may execute the ASA 204, the MCI 206, the DSI 208, the OBPSA 210, the USI 212, the DIASA 214, and the DMSA 215 to provide API services to end users. FIGS. 3-8 are example block diagrams illustrating the various modules of the ASA 204, the MCI 206, the DSI 208, the OBPSA 210, the USI 212, the DIASA 214, and the DMSA 215.

FIG. 3 is an example block diagram of the ASA 204, according to one embodiment. The ASA 204 includes one or more discrete API services, or modules, such as service #1 302 and service #N 304. For example, the ASA 204 may include a “product” API service. The product API service may retrieve business data related to products, such as inventory levels for a particular product, store business product data, and/or generate new business product data. As another example, the API services application 204 may include a “customer” API service. The customer API service may retrieve business data related to customers, such as customer name and address, modify existing business data such as a customer order, and/or generate new business data. In yet another example, the information technology department of a large business enterprise may require login credentials for access to a multiple heterogeneous proprietary business databases. Rather than employing different authorization and/or credentialing implementations for each database, the IT developer may use an “authorization” API service to provide access to all of the databases. In yet another example, a large business may have an information helpdesk as well as a Human Resources help desk. Rather than implementing two different ticketing applications for each respective helpdesk, an IT developer may access a “ticket” API service offering core helpdesk ticket functionalities to provide access to each respective helpdesk. It is contemplated that the ASA 204 may include N number of API services, some of which may include: a product API service, a resource API service, an invoice API service, an order API service, a customer API service, a ticket API service, etc. It is contemplated that the API services may encapsulate any type of business functionality for a business asset and/or access to any type of business data available from a business asset.

Each API service may be executed inside of a service container. For example, a service may be implemented using the java programming language and implemented in tcServer™, JBoss™, and/or Weblogic™ service containers. As another example, a service may be implemented in C# and executed in a Microsoft IIS™ container. Other service and service container combinations may also be used. In another implementation, the service containers may be monitored. For example, the services may be monitored using Quest Foglight™. Quest Foglight provides agents that monitor various services to provide runtime governance and service performance metrics. According to one aspect, the service containers may embody the runtime environment for an API service. Containers may contain built-in monitoring of deployed API services (e.g. Java Management Extensions—JMX) or third party agents (e.g. Quest Foglight) may be deployed to a container using the standard mechanisms for the runtime container and configured to instrument the processing of an API service call. The instrumentation of the monitoring may then be accessed by web dashboards or output to an Enterprise Monitoring System (EMS) for broader IT operations visibility.

FIG. 4 is an example block diagram of the OBPSA 210 according to one embodiment. The OBPSA 210 includes one or more orchestrated business process services 404 and 402 that combine one or more of the API services offered by the ASA 204, into an orchestrated business service. For example, the OBPSA 210 may combine individual API services from the API services application 204 including: an invoice API service, an order API service, and a customer API service into an orchestrated business service process that may be used to automatically perform and/or provide the more complex business capability of processing customer product returns. The OBPSA 210 may be realized using either implementations of process execution standards like Business Process Execution Language (BPEL) or Business Process Management Notation (BPMN) or by using proprietary process execution implementations like Microsoft BizTale or Tibco Businessworks™. Additionally, services may be orchestrated via direct programming of process logic and therefore usage of a process execution platform is not a requirement.

FIG. 5 is an example block diagram of the DSI 208. The DSI 208 unifies and extends existing information architectures' data access capabilities. According to one aspect, the DSI 208 includes instructions and/or modules that make real-time business data more accessible and usable by exposing the business data as a unified business data view.

For example, the DSI 208 may include a receiving module 502 and a processing module 504. The receiving module 502 receives business data from one or more disparate business assets, from the application platform 106 and/or the data management platform 108. The business data may be unreconciled, which means the data comes from at least two different business assets with discrepancies, or fragments. For example, assume a business B has two employee databases: a SQL Server™ managed employee database and an Oracle DMBS™ managed employee database. A developer does a query in the SQL Server database for an employee named John Doe, in an attempt to receive information regarding John's salary and current department. The SQL Server database returns business data indicating that John Doe is currently being paid $100,000, but has no data regarding the department in which John works. The developer does a separate query in the Oracle DMBS database for John Doe. The Oracle DMBS database returns business data indicating that John Doe works in the accounting department, but has no data regarding John's salary. Thus, the data regarding the employee John Doe is fragmented and/or incomplete between the two databases, or one database has information different than the other database.

The processing module 504 reconciles the unreconciled business data received by the receiving module 502 into a single point of access, and exposes the business data in a unified information view. Subsequently, developers may access the business data through the single point of access to enable the API Services (provide the appropriate data to the API Services to allow the API Services to perform their intended functions) offered by the API services application 204. Referring to the John Doe example above, the DSI 208 unifies the business data regarding John's salary from the SQL Server database and the business data regarding John's department from the Oracle DMBS database into one complete data record for access.

Thus the modules of the DSI 208 combine data from data sources such as the application platform 106, the data management platform 108, or both to provide unified access to fragmented or multi-source data sets. Combining such data frees up the IT developers from having to know the location and the technical implementation of the data sources (i.e. the source could be Excel spreadsheet, RDBMS, XML datafile) and gives the developers a single point of access and single technical access mechanism (e.g. JDBC/SQL or web service) to get at distributed and/or fragmented business data. Thus, the DSI 208 is the technical mechanism by which data is unified and allows the data in the sources to remain unchanged as implemented by the source technical resource. Agility is achieved by not having to change or modify different data sources; rather, DSI 208 infrastructure of the services platform 104 reconciles such data.

The DIASA 214 provides a data extraction, transformation and loading (ETL), and a data change event special purpose service for the services platform 104, to enable the processing and movement of distributed sources of data, on or off premise, from the distributed sources into another data source such as the data management platform 108.

FIG. 7 is an example block diagram of the MCI 206 according to one embodiment. The MCI 206 coordinates communications among the various components in the services platform 104. The MCI 206 may be implemented based on four distinct architectural layer modules including an API service mediation layer module 702, a store and forward transactional message layer module MCI 704, a high performance publish and subscribe message layer module MCI 706, and a managed file transfer message layer module MCI 708. Other layers may also be included where distinct managed communications between distributed components is required.

The API service mediation layer 702 provides a centralized Policy Enforcement Point (PEP) for service communications. For example, the API service mediation layer module 702 may control message traffic according to a defined set of policies, such as authentication, authorization and auditing; sensitive data obfuscation, masking and/or filtering; dynamic service location and routing; version management and mapping; and threat detection and content scanning. According to one aspect, the API service mediation layer 702 may implement these policies within the layer itself, or it may implement calls to external infrastructure services.

The PEP is implemented via a centralized proxy technology mechanism. All API service invocations from consumers are made to a single host (e.g. api.level3.com) and these invocations are mediated by the proxy technology where, based on the uniform addressing scheme of the API service, the PEP can apply ‘N’ number of policies to the invocation (e.g. authenticate, authorize, route to provider, throttle call etc. . . . ). Policies are declaratively set up in the PEP based on the API services that are mediated and can be modified/changed at runtime to dynamically change how the PEP deals with subsequent API service invocations. Additional local policy enforcement can be implemented by the API services themselves or with a PEP that is deployed locally to the Service Container hosting the API service.

The store and forward transactional message layer MCI 704 provides standard based messaging transport between the various components of the services platform 104. For example, the store and forward transactional message layer MCI 704 may provide additional Quality of Service (QOS) capabilities like reliable delivery and once and only once delivery of messages between the various components of the services platform 104 and is used to enable Event Driven Architecture (EDA) patterns. According to one aspect, the store and forward transactional message layer may be implemented based on TIBCO Enterprise Messaging Service (EMS)™. Alternate store and forward mechanisms like MQSeries from IBM™ can be used for this layer. To achieve standard messaging, The MCI 704 may be implemented via the Java Message Service (JMS) which provides the standard semantics for messaging and provides reliable store and forward delivery of messages for service consumers who may operate temporarily in a disconnected state and upon reconnect retrieve and process their API service invocations.

The high performance publish and subscribe message layer module MCI 706 provides a high performance message transport between a publisher and multiple subscribers. A message publisher produces business data and context (topic/subject) messages that use the high performance publish and subscribe message layer module MCI 706 to communicate the business data and context based messages to interested listeners. A subscriber is defined as a listener of business data and context messages that uses the high performance publish and subscribe message layer module MCI 706 to receive messages of interest. Subscribers use context filters (topic/subject) to limit the scope of messages that they receive and process. The high performance publish and subscribe message layer module MCI 706 provides rapid delivery to large numbers of subscribers and is used in business scenarios that require quick and broad dissemination of interesting business events.

The managed file transfer message layer module MCI 708 provides a robust and secure mechanism for batch file transfer and batch file processing workflow. The managed file transfer message layer module MCI 708 is used to transfer large blocks or files of data between components in the services platform 104 and makes it possible to reliably start, process, and re-start if necessary communications to ensure block or file information exchange is successfully completed. According to one aspect, managed file transfer message layer module MCI 708 can be implemented by the File Transfer Protocol (FTP). Alternate mechanisms may include the Secure Copy Protocol (SCP) or 3^{rd} party implementations like Axway™.

FIG. 8 is an example block diagram of the USI 212. The USI 212 includes one or more services or modules that provide common shared utility and management functions to the services platform 104. For example, in one embodiment, the USI 212 includes a security services module 802, an activity monitoring service module 804 and an audit service module 806. Other modules may also be included. The security services module 802 uses an API access key combined with a secret access key to control access to the services of the ASA 204.

The activity service monitoring module 804 captures metrics for API service invocations provided by the ASA 204 and enables alerting mechanisms based off of the API service invocation and/or its messages content. For example, an alerting mechanism may entail the setting of a performance service level (SLA) on the Order Status API service to provide a response within 5 seconds or less and the activity monitoring service module measures the latency of each service invocation and has programmed policies to proactively alert operations managers if invocation response time begins to exceed the 5 second SLA.

The audit service module 806 may be called by the service mediation layer 702 of the MCI 206 to monitor traffic and access control of the ASA 204 and provide metrics, such as overall API service use. Monitoring of the API services is achieved by tracking and instrumenting the service invocations. Requests for service and the responses from services, including successes and failures, are intercepted by the AMM 806 and ASM 808 and policies are applied at the point of interception to count and/or capture the invocation transactional data for in-band runtime action (e.g. SLA alerting) or for later out-of-band metrics aggregation and reporting to be used in decision support and management of the service platform. Audit logs and transaction logs can then be used with standard tools to introspect the operations of the entire service network.

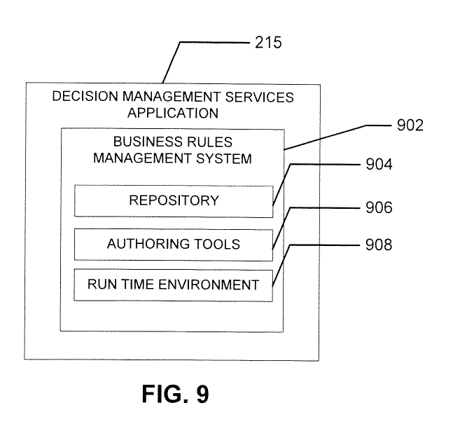

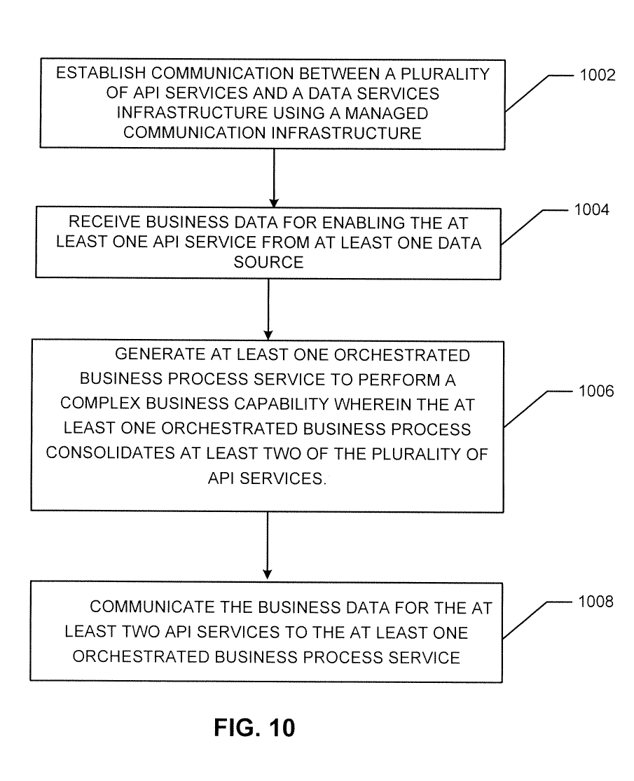

FIG. 9 is an example block diagram of the DMSA 215 according to one embodiment. The DMSA 215 includes a Business Rules Management System (BRMS) 902 that may include a repository 904 to contain externalized rules/policies. The BRMS 902 may also include an authoring tools module 906 for allowing business or technical users to define, manage, test, and validate the rules and/or policies. Finally, the BRMS 902 may include a runtime environment 908 which allows applications or services, such as services defined by the ASA 204 and/or the OBPSA 210, to invoke decision logic and receive a decision back for use in processing.

For example, assume and API service called “order fulfillment process service” provides the business capability of routing orders to a VIP processing group to fulfill orders for VIP customers. In such a service, the rules for routing orders to the VIP processing group may change regularly when new VIP customer's are added, or when dollar amounts change indicating the amount of money a customer must spend to be considered VIP. Instead of codifying the rules in the fulfillment business process service, which would have to be continually changed if and/or when the rules change, the rules are externalized in a decision management service which takes the order data as input and outputs a “VIP” or “Not VIP” ruling that the fulfillment business process service uses to send the order to the correct fulfillment group.

FIG. 10 is an example method for providing access to a plurality of API services wherein each API service of the plurality of API services accesses a business asset to implement a business capability. At 1002, communication between the plurality of API services and a data services infrastructure is established using a managed communication infrastructure. For example, a business worker uses a mobile tablet device as a delivery channel 110 and communicates with the communication network 112 to sign-on to the services system 102. The sign-on request is handled by the services platform 104 which communicates via the MCI 206 to the utility services infrastructure 212 where the user is authenticated by the security services module 802. Once signed on, the business worker requests customer account data from the “Customer” API service; this request is handled by the services platform 104, API services 204 which communicates via the MCI 206, service mediation layer module 702 via the communication network 112 to the application platform 106 to access the customer master application to return detail on a specific customer. The business worker then requests a “Credit Check” for the customer based on a pending order from the customer for $50,000. The request is handled by the “Credit Check” API service, which is a composite orchestrated service. The request is handled by the services platform 104 which communicates via the MCI 206 to the OBPSA 210 which sequences a series of service calls using the API services 204. The 1^{st} sequence call retrieves a credit profile from the “Credit Profile” API service, the second sequence call retrieves outstanding payables and uses the DSI 208 to access a unified view of outstanding payables across 2 applications in the application platform 106 and 1 data source in the data management platform 108. The OBPSA 210 then takes the result of the two sequenced calls and communicates those to the business worker via the communication network 112 and the mobile device delivery channel 110 where the result is examined and communicated to the customer. While this sequence of API services calls is taking place, the MCI 206 is communicating with the utility services infrastructure 212 where the activity monitoring module 804 and audit services module 806 are instrumenting the service invocations for runtime monitoring and alerting and for subsequent metrics reporting and operations management. At 1004, business data for enabling the at least one API service is received from at least one data source. For example, data is received from the data management platform 110. At least one orchestrated business process service is generated to perform a complex business capability, wherein the at least one orchestrated business process consolidates or otherwise orchestrates at least two of the plurality of API services at 1006. For example, a “decomposition” orchestrated business process service for order management is generated by the OBPSA 210 that orchestrates an “order” API service and a “product” API service. The business data for the at least two API services is communicated to the at least one orchestrated business process service at 1008. For example, the business data is communicated to the “decomposition” orchestrated business process service through the OBPSA 210 using the MCI 206.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. An enterprise information technology platform comprising:
at least one processor;
a memory in operable communication with the at least one processor; and
a services platform, executing on the at least one processor, comprising:
a plurality of API services, wherein each API service of the plurality of API services accesses one or more business assets to implement a business capability;
a data services infrastructure to:
receive business data comprising unreconciled business data from at least one data source and at least one business application; and
reconcile the business data without modifying the at least one data source and the at least one business application by:
virtualizing the at least one data source and the at least one business application to generate a single data access point to access reconciled business data; and
exposing the reconciled business data in a unified information view, the reconciled business data used to enable at least one API service of the plurality of API services;
at least one orchestrated business process service to consolidate at least two of the plurality of API services to enable a complex business capability; and
a management communications infrastructure to:
coordinate communication between the plurality of API services to enable selection of the at least two API services; and
communicate the business data from the data services infrastructure for the at least two API services to the at least one orchestrated business process service.

2. The system of claim 1, wherein the management communications infrastructure is further configured to communicate with one or more delivery and consumption channels to enable access to the complex business capability.

3. The system of claim 1, wherein the management communications infrastructure is further configured to communicate with one or more delivery and consumption channels to enable access to one of the plurality of API services.

4. The system of claim 1, wherein:
the services platform further comprises a utility service infrastructure; and
the management communications infrastructure communicates with the utility services infrastructure to provide monitoring of at least one API service invocation by:
instrumenting the at least one API service invocation; and
capturing metrics for the at least one API service invocation to enable at least one alerting mechanism.

5. The system of claim 1, wherein the services platform further comprises a data integration and acquisition services application to process business data from the at least one data source, the at least one business application, and another data source.

6. (canceled)

7. The system of claim 1, wherein the management communication infrastructure comprises:
an API service mediation layer to provide a policy enforcement point for communication between the plurality of API services;
a store and forward transactional layer to perform standard messaging between the plurality of API services, the at least one orchestrated business process and the data services infrastructure on the services platform;
a high performance publish and subscribe message layer to transport messages between at least one publisher and at least one subscriber; and
a managed file transfer message layer to transfer the business data through the services platform.

8. The system of claim 1, wherein each API service implements the business capability based on a business asset functionality corresponding to the one or more business assets accessed by each API service.

9. The system of claim 1, wherein the services platform further comprises a decision management services application to externalize business policies and rules from the plurality of API services.

10. A method for providing access to a plurality of API services, wherein each wherein each API service of the plurality of API services accesses a business asset to implement a business capability, the method comprising:
establishing, at a processor, communication between the plurality of API services and a data services infrastructure;
receiving, at the processor, business data comprising unreconciled business data from at least one data source and at least one business application;
reconciling, at the processor, the business data without modifying the at least one data sources and the at least one business application by:
virtualizing the at least one data source and the at least one business application to generate a single data access point to access reconciled business data; and
exposing the reconciled business data in a unified information view, the reconciled business data used for enabling at least one API service of the plurality of API services;
generating, at the processor, at least one orchestrated business process service to perform a complex business capability, wherein the at least one orchestrated business process consolidates at least two of the plurality of API services; and
communicating, using the processor, the business data for the at least two API services to the at least one orchestrated business process service.

11. The method of claim 10, further comprising communicating, using the processor, with one or more delivery and consumption channels to enable access to the complex business capability.

12. The method of claim 10, further comprising communicating, using the processor, with one or more delivery and consumption channels to enable access to at least one of the plurality of API services.

13. (canceled)

14. The method of claim 10, wherein each API service implements the business capability based on a business asset functionality corresponding to the one or more business assets accessed by each API service.

15. A non-transitory computer-readable medium encoded with a services platform comprising one or more applications and infrastructures executable by a processor comprising:
an API services application comprising a plurality of API services wherein each API service of the plurality of API services accesses one or more business assets to implement a business capability;
a data services infrastructure to:
receive business data comprising unreconciled business data from at least one data sources and at least one business application; and
reconcile the business data without modifying the at least one data source and the at least one business application at by:
virtualizing the at least one data source and the at least one business application to generate a single data access point to access reconciled business data; and
exposing the reconciled business data in a unified information view, the reconciled business data used to enable at least one API service of the plurality of API services;
a orchestrated business process service application to generate at least one orchestrated business process service to consolidate at least two of the plurality of API services to enable a complex business capability;
a management communications infrastructure to:
coordinate communication between the plurality of API services to enable selection of the at least two API services; and
communicate the business data from the data services infrastructure for the at least two API services to the at least one orchestrated business process service.

16. The computer-readable medium of claim 15, wherein the management communications infrastructure is further configured to communicate with one or more delivery and consumption channels to enable access to the complex business capability.

17. The computer-readable medium of claim 15, wherein the management communications infrastructure is further configured to communicate with one or more delivery and consumption channels to enable access to one of the plurality of API services.

18. The computer-readable medium of claim 15, wherein the services platform further comprises a utility service infrastructure to provide secure access to the services platform and wherein the management communications infrastructure is further configured to enable secure communication between the utility services infrastructure, to at least one of the plurality of API services, and the at least one orchestrated business process service.

19. The computer-readable medium of claim 15, wherein the services platform further comprises a data integration and acquisition services application to process business data from the at least one data source, the at least one business application, and another data source.

20. (canceled)

21. The computer-readable medium of claim 15, wherein the management communication infrastructure comprises:
an API service mediation layer to provide a policy enforcement point for communication between the plurality of API services;
a store and forward transactional layer to perform standard messaging between the plurality of API services, the at least one orchestrated business process and the data services infrastructure on the services platform;
a high performance publish and subscribe message layer to transport messages between at least one publisher and at least one subscriber; and
a managed file transfer message layer to transfer the business data through the services platform.

22. The computer-readable medium of claim 15, wherein each API service implements the business capability based on a business asset functionality corresponding to the one or more business assets accessed by each API service.

23. The system of claim 1, wherein each API service of the plurality of API services is a standardized interface comprising a data infoset to provide the reconciled business data and a uniform addressing scheme to locate API services in the plurality of API services.
